(19) United States
(12) Patent Application Publication
(10) Pub. No.: US 2005/0177763 A1
(43) Pub. Date: Aug. 11, 2005

(54) System and method for improving network reliability

(75) Inventor: Assaf Stoler, Graden Grove, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Matsushita Avionics Systems Corporation

(21) Appl. No.: 10/773,523

(22) Filed: Feb. 6, 2004

(51) Int. Cl. G06F 11/00

(52) U.S. Cl. 714/4

(57) ABSTRACT

A network management system for detecting and remedying malfunctions in network devices and methods for manufacturing and using same. The network management system can receive status signals from a network system having one or more network devices. The status signals provide information, such as an operational status and/or current performance data, for at least one preselected network device. Upon analyzing the status signals, the network management system can determine whether the preselected network device has malfunctioned and identify appropriate corrective action for remedying the malfunction. The network management system likewise can generate a control signal, which includes appropriate corrective action, and can provide the control signal to the preselected network device via the network system. The preselected network device can implement the corrective action in accordance with any implementation instructions included therewith. Thereby, the network management system is configured to detect and remedy malfunctions in the network devices.

### FIELD OF THE INVENTION

The present invention relates generally to network management systems and more particularly, but not exclusively, to network management systems for detecting and remedying malfunctions in network devices.

### BACKGROUND OF THE INVENTION

As computer systems and networks continue to become more integral in the manner by which business and personal matters are conducted, system users have grown more dependent upon the reliability of these systems. System manufacturers and users therefore have grown increasingly concerned with system malfunctions.

Detecting and responding to system malfunctions can prove difficult due to the complexity of current network systems as well as the large number of local and remote computer systems that can be coupled therewith. Further, computer systems and networks can malfunction as a result of any of a variety of causes and can become manifest in an assortment of different ways. If his computer system or network experiences a malfunction, therefore, a user typically will be become aware of the malfunction but will only be able to speculate as to the precise nature and cause of the malfunction.

Network management systems have been developed to assist with the management of computer systems and networks. Since network systems can support a significant volume of information and a large number of network devices, contemporary network management systems must be able to support large network systems and be scalable to manage any number of network devices. In addition to being cost-effective, the network management systems also must maintain consistent performance and reliability. It is necessary, therefore, to test the network management systems for scalability, performance, and reliability prior to deployment as well as afterward to ensure that consistent performance and reliability can be maintained.

In view of the foregoing, a need exists for an improved network management system that overcomes the aforementioned obstacles and deficiencies of currently-available network management systems.

### SUMMARY OF THE INVENTION

The present invention is directed toward a network management system for detecting malfunctions in network devices and for generating appropriate responses to remedy the malfunctions.

An information system can include a network management system that is configured to communicate with a network system, which includes a communication network and one or more network devices. Being configured to detect and remedy malfunctions in the network devices, the network management system can receive status signals from the network system. The status signals provide information, such as an operational status and/or current performance data, for at least one preselected network device. Upon analyzing the status signals, the network management system can determine whether the preselected network device has malfunctioned and can identify appropriate corrective action for remedying the malfunction.

The network management system likewise can generate a control signal, which includes information related to the appropriate corrective action, and can provide the control signal to the network system. The network system can receive the control signal from the network management system and provide the control signal to the preselected network device. Upon receiving the control signal, the preselected network device is configured to implement the corrective action identified in the control signal in accordance with any implementation instructions included therewith. Thereby, the network management system is configured to detect and remedy malfunctions in the network devices.

Other aspects and features of the present invention will become apparent from consideration of the following description taken in conjunction with the accompanying drawings.

### BRIEF DESCRIPTION OF THE DRAWING

FIG. 1 is an exemplary top-level block diagram of an embodiment of an information system that is configured to detect and remedy malfunctions in network devices.

FIG. 2 is an exemplary block diagram illustrating one embodiment of a network management system and a network system for the information system of FIG. 1.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present invention. The figures do not describe every aspect of the present invention and do not limit the scope of the invention.

### DETAILED DESCRIPTION OF THE PREFERRED EMBODIMENTS

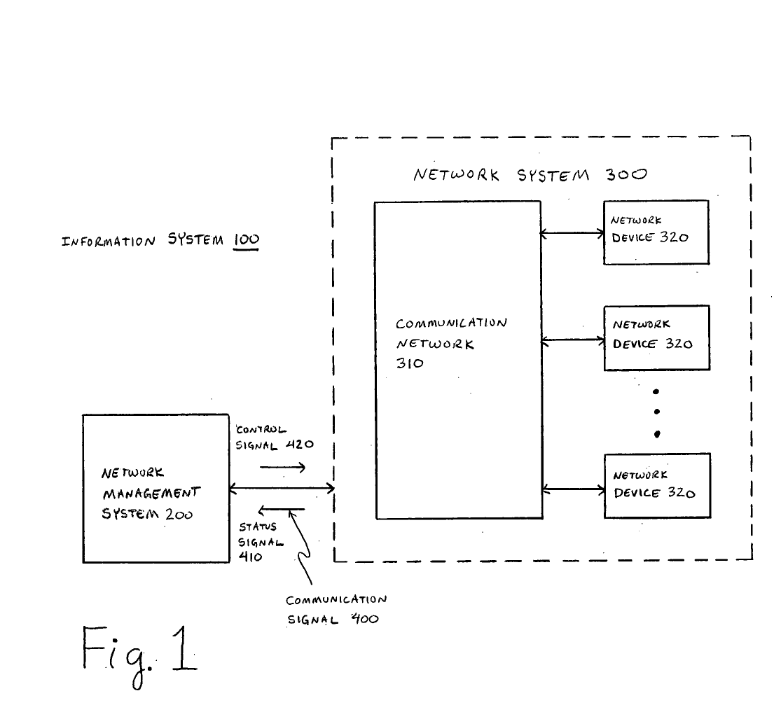

Since currently-available network management systems provide limited scalability, performance, and reliability, a network management system that can support large network systems with any number of network devices can prove much more desirable and provide a basis for a wide range of information system applications, such as passenger entertainment systems for use on aircraft and other types of vehicles. This result can be achieved, according to one embodiment of the present invention, by employing information system 100 as shown in FIG. 1.

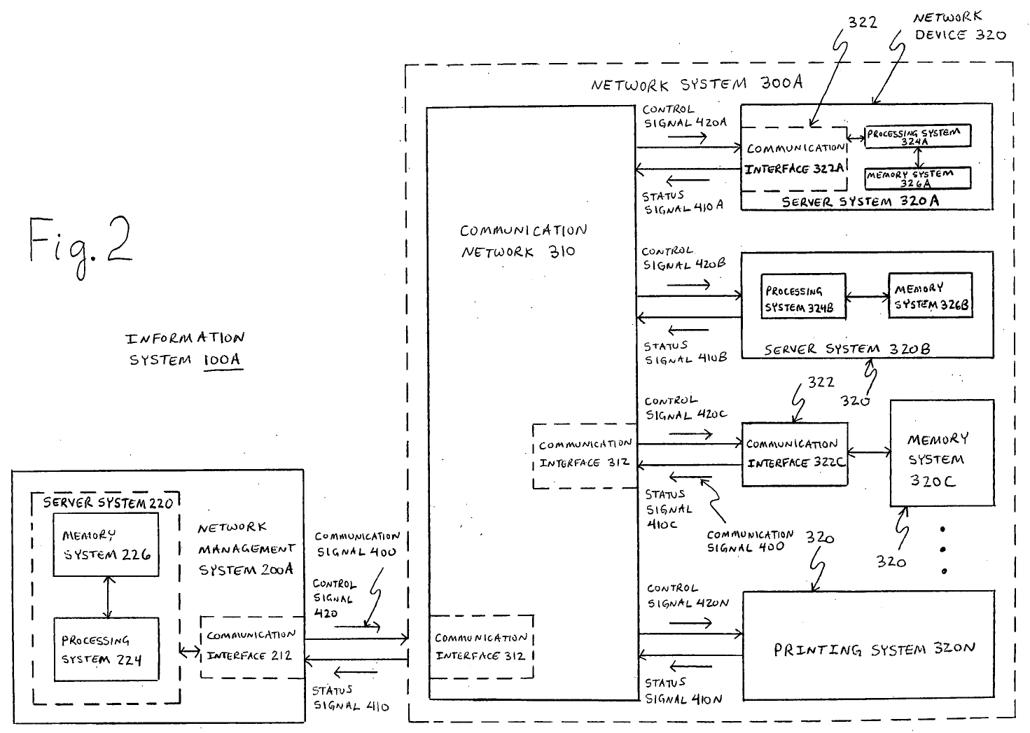

The information system 100 shown in FIG. 1 includes a network management system 200 that is configured to communicate with a network system 300. Typically being provided as a conventional computer network system, the network system 300 can comprise a network system of any kind and, for example, can include a communication network 310 and one or more network devices 320 as illustrated in FIG. 1. The communication network 310 can be provided as any appropriate type of communication network, including a wired communication network and/or a wireless communication network. Likewise, the network devices 320 can comprise any suitable type of network devices, such as a server system 320A, 320B (shown in FIG. 2), a memory system 320C (shown in FIG. 2), and/or a printing system 320N (shown in FIG. 2), and are configured to communicate via the communication network 310.

Being configured to detect and remedy malfunctions in the network devices 320, the network management system 200 can be provided in any suitable manner, such as via one or more hardware components and/or software components, and can exchange communication signals 400 with the network system 300. For example, the network management system 200 can receive one or more status signals 410 from the network system 300. Each status signal 410 includes information, such as an operational status and/or current performance data, that is associated with at least one preselected network device 320. Upon receiving the status signals 410, the network management system 200 is configured to analyze the information provided by the status signals 410 to determine whether a malfunction has occurred with regard to the preselected network device 320.

If the preselected network device 320 has malfunctioned, the network management system 200 can identify one or more appropriate corrective action for remedying the malfunction. Exemplary corrective measures include restarting the preselected network device 320, restarting substantially the entire network system 300, and/or diverting the tasks assigned to the preselected network device 320 to one or more other network devices 320. The network management system 200 likewise can elect to ignore the malfunction such that no corrective action is taken to remedy the malfunction.

The network management system 200 then can generate a control signal 420, which includes information related to the appropriate corrective action, and can provide the control signal 420 to the network system 300. If network management system 200 determines that the malfunction may be remedied by more than one corrective action, such as two or more corrective actions in the alternative and/or in combination, instruction for implementing the corrective action can be included in the information provided by the control signal 420. Exemplary instructions include a sequence by which the corrective actions can be implemented.

The network system 300 can receive the control signal 420 from the network management system 200 and provide the control signal 420 to the preselected network device 320 via the communication network 310. Upon receiving the control signal 420, the preselected network device 320 is configured to implement the corrective action identified in the control signal 420 in accordance with any implementation instructions included therewith. Thereby, the network management system 200 is configured to detect and remedy malfunctions, if any, in the network devices 320, preferably in a manner that is substantially transparent to system users. Although shown and described as comprising one network management system 200 and one network system 300 for purposes of illustration, it is understood that the information system 100 can include any number of network management systems 200 each of which can be configured to communicate with any number of network systems 300.

Turning to FIG. 2, for example, the information system 100A is shown as comprising a network management system 200A and a network system 300A. In the manner discussed in more detail above regarding the network system 300 (shown in FIG. 1), the network system 300A can comprise a network system of any kind and, for example, can include a communication network 310 and one or more network devices 320 as illustrated in FIG. 2. Being configured to distribute communication signals 400 among any predetermined number of network devices 320, the communication network 310 can comprise any suitable type of communication network, such as one or more wired communication networks and/or wireless communication networks. Illustrative communication networks include local area networks (LANs), wide area networks (WANs), and wireless local area networks (WLANs) of any kind. Exemplary wireless local area networks include wireless fidelity (Wi-Fi) networks in accordance with Institute of Electrical and Electronics Engineers (IEEE) Standard 802.11 and/or wireless metropolitan-area networks (MANs), which also are known as WiMax Wireless Broadband, in accordance with IEEE Standard 802.16.

Being configured to exchange communication signals 400 with the network management system 200A via the communication network 310, the network devices 320 each can comprise any suitable type of conventional network device, including hardware-based network devices and/or software-based network devices, without limitation. As illustrated in FIG. 2, for example, the network devices 320 can include one or more server systems 320A, 320B, memory systems 320C, and/or printing systems 320N. Being configured to perform at least one preselected function, each network device 320 can be deemed to have malfunctioned when the network device 320 cannot perform one or more of the preselected functions. Such malfunctions can occur for many reasons, including improper power levels, inability to execute instructions, and/or inability for network devices 320 to communicate. Further, a malfunction in a first network device 320 may result in one or more other network devices 320 malfunctioning.

While operating properly, the network devices 320 preferably are configured to provide one or more status signals 410. The status signals 410 include information, such as an operational status and/or current performance data, for the associated network device 320. Exemplary information provided with the status signals 410 can be information related to whether the associated network device 320 is operational. The network devices 320 can provide the status signals 410 to the communication network 310, which is configured to communicate the status signals 410 to the network management system 200A.

Each network device 320 preferably provides the status signals 410 at approximately a preselected time interval that is substantially within a predetermined range of time intervals. The preselected time intervals can differ, or be substantially uniform, between adjacent status signals and/or among the network devices 320. Typically being less than or substantially equal to thirty seconds (30 sec.), the preselected time intervals can comprise any preselected amount of time and preferably is within the range between approximately one second (1 sec.) and fifteen seconds (15 sec.), inclusively. The preselected time intervals can be within any range of time intervals, including, for example, any five second (5 sec.) range, such as between three seconds (3 sec.) and eight seconds (8 sec.), between substantially one second (1 sec.) and thirty seconds (30 sec.).

Comprising processing systems 324A, 324B and memory systems 326A, 326B, respectively, the server systems 320A, 320B each can be provided as any type of server system. The server systems 320A, 320B typically include one or more computer systems, such as personal computer systems, which are coupled, and configured to communicate, via as a computer network (not shown), such as a local area network (LAN) and/or a wide area network (WAN), of any kind. The server systems 320A, 320B are configured to receive information, such as data and/or instructions, from the network management system 200A and/or other network devices 320 via the communication network 310 and to perform one or more functions, as necessary, in response to the received information. Upon performing the functions, the server systems 320A, 320B can provide the result, if any, of the functions to the communication network 310.

The memory systems 326A, 326B are respectively configured to store and provide information, including instruction code, such as software or firmware, intermediate calculation results, and other information associated with the processing system 324A, 324B and/or performance data related to the current and/or historical operational status of the processing system 324A, 324B. Preferably comprising non-volatile memory systems, the memory systems 326A, 326B can comprise any suitable type of memory system, such as any electronic, magnetic, and/or optical storage media, without limitation. For example, exemplary storage media can include one or more static random access memories (SRAMs), dynamic random access memories (DRAMs), electrically-erasable programmable read-only memories (EEPROMs), FLASH memories, hard drives (HDDs), compact disks (CDs), and/or digital video disks (DVDs) of any kind.

Being coupled with, and configured to communicate with, the memory systems 326A, 326B, the processing systems 324A, 324B can comprise any type of processing system, such as one or more microprocessors (μPs), central processing units (CPUs) and/or digital signal processors (DSPs) of any kind. The processing systems 324A, 324B is configured to receive information, such as data and/or instructions, from the network management system 200A and/or other network devices 320 via the communication network 310 and to perform one or more functions, as necessary, in response to the received information. The processing systems 324A, 324B can provide the result, if any, of the functions to the communication network 310.

Other types of network devices 320, such as the memory system 320C and/or the printing system 320N shown in FIG. 2, can be coupled with the communication network 310 in any suitable quantity and/or arrangement. Comprise any type of conventional memory system, the memory system 320C can be provided in the manner discussed above with reference to the memory systems 326A, 326B. The memory system 320C can be configured to store and provide information, including instruction code, such as software or firmware, system data, and other information associated with the network system 300A and/or performance data related to the current and/or historical operational status of the network system 300A. The printing system 320N can be provided as any type of conventional printing system, including one or more laser printers, dot matrix printers, and/or plotters, without limitation. It will be appreciated that any type of conventional network devices 320 can be coupled with the communication network 310.

Being configured to communicate via the communication network 310, the network devices 320 can be coupled with the communication network 310 via, for example, a communication interface 322. As illustrated in FIG. 2, the server system 320A is coupled with, and configured to communicate with, the communication network 310 via a communication interface 322A. The communication interface 322A is disposed substantially between the server system 320A and the communication network 310 and is configured to facilitate the exchange of the communications signals 400 between the server system 320A and the communication network 310, and, therefore, other network devices 320 and/or the network management system 200A. If the communication network 310 comprises a telephone network (not shown), for example, the communication interface 322A can comprise a modem for coupling the server system 320A with the telephone network.

Although shown and described as being disposed substantially within the server system 320A, the communication interface 322A can be disposed substantially within, or separate from, the server system 320A. For example, FIG. 2 shows the memory system 320C as being coupled with the communication network 310 via a communication interface 322C. Being provided in the manner described above with reference to the communication interface 322A, the communication interface 322C as illustrated in FIG. 2 is substantially separate from the memory system 320C. The communication interface 322C is disposed substantially between the memory system 320C and the communication network 310 and is configured to facilitate the exchange of the communications signals 400 between the memory system 320C and the communication network 310, and, therefore, other network devices 320 and/or the network management system 200A in the manner discussed above. As desired, other network devices 320, such as the server system 320B and the printing system 320N, can be substantially directly coupled with the communication network 310.

The communication network 310 likewise can include one or more communication interfaces 312 for facilitating the exchange of the communications signals 400 among the network devices 320 and/or the network management system 200A as shown in FIG. 2. Being provided in the manner described above with reference to the communication interfaces 322A, 322C, the communication interfaces 312 can disposed substantially within, or separate from, the communication network 310. As illustrated in FIG. 2, the communication system 310 and the network devices 320 can be coupled in any suitable manner such that the communications signals 400 can be exchanged among the network devices 320 and/or the network management system 200A. In the manner discussed above, for example, the communication system 310 can be coupled with a selected network device 320 directly in the manner described above with reference to the server system 320B, indirectly via one communication interface 322 in the manner described above with reference to the server system 320A, or two communication interfaces 312, 322C in the manner described above with reference to the memory system 320C.

Being configured to detect and remedy malfunctions in the network devices 320, the network management system 200A includes a server system 220 for receiving and analyzing the status signals 410 provided by the network devices 320 and for generating a control signal 420, as necessary, to provide appropriate corrective action to the network devices 320 for remedying any malfunctions. In the manner described above regarding the server system 320A, the server system 200 can comprise any type of server system and, as illustrated in FIG. 2, includes a processing system 224 that is coupled with, and configured to communicate with, a memory system 226. The processing system 224 and the memory system 226 likewise can be provided in the manner discussed above with reference to the processing system 324A and the memory system 326A, respectively. The memory system 226 can store and provide information, including instruction code, such as software or firmware, intermediate calculation results, and other information associated with the processing system 224 and/or performance data related to the current and/or historical operational status of the network devices 320 and/or the network management system 200A.

Being configured to communicate with the network system 300A, the network management system 200A can be coupled with the communication network 310 in any manner, including directly or indirectly via, for example, a communication interface 212. In the manner described above with regard to the communication interface 322A, the communication interface 212 is disposed substantially between the network management system 200A and the communication network 310 and is configured to facilitate the exchange of the communications signals 400 between the network management system 200A and the communication network 310, and, therefore, the network devices 320. As desired, the communication interface 212 can be separate from, or disposed substantially within, the network management system 200A and can be provided in the manner described above with reference to the communication interfaces 322A, 322C. As discussed above, the communication network 310 likewise can include the communication interface 312 for facilitating the exchange of the communications signals 400 with the network management system 200A as shown in FIG. 2.

Upon receiving a selected status signal 410A from the server system 320A, for example, the network management system 200A analyzes the selected status signal 410A to determine whether the server system 320A is operating properly. Since the server system 320A preferably is configured to provide the selected status signal 410A at a preselected time interval within a predetermined range of time intervals, the network management system 200A likewise may determine that the server system 320A has malfunction if the selected status signal 410A is not received within the predetermined range.

Upon determining that the server system 320A is operating properly, the network management system 200A preferably disregards the selected status signal 410A pending receipt of a subsequent status signal 410A. If the network management system 200A detects a malfunction in the server system 320A, the network management system 200A is configured to identify one or more corrective actions for remedying the malfunction. Exemplary corrective measures include restarting the preselected network device 320, installing a file on the preselected network device 320, deleting a file from the preselected network device 320, installing a file on the preselected network device 320, restarting substantially the entire network system 300, adding a system resource to the network system 300, deleting a system resource from the network system 300, and/or diverting the tasks assigned to the preselected network device 320 to one or more other network devices 320. The network management system 200A likewise can elect to ignore the malfunction such that no corrective action is taken to remedy the malfunction.

The network management system 200A can identify one or more corrective actions for remedying the malfunction in any appropriate manner. For example, a database system (not shown) of potential corrective actions for remedying the malfunction can be stored in, and recallable from, the memory system 226. The network management system 200A can examine the database system and compare the current operational status of the server system 320A with a table of preselected, known statuses of the server system 320A as provided by the database system. If network management system 200A determines that the malfunction may be remedied by more than one corrective action, such as two or more corrective actions in the alternative and/or in combination, instruction for implementing the corrective action can be included in the information provided by the control signal 420. Exemplary instructions include a sequence by which the corrective actions can be implemented.

Upon identifying the appropriate corrective action for remedying the malfunction, the network management system 200A can generate a control signal 420A, which includes information related to the appropriate corrective action, and can provide the control signal 420A to the server system 320A via the communication network 310. The server system 320A can receive the control signal 420A and is configured to implement the corrective action identified in the control signal 420A in accordance with any implementation instructions included therewith. Thereby, the network management system 200A is configured to detect and remedy malfunctions, if any, in the server system 320A.

The network management system 200A likewise can detect and remedy malfunctions, if any, in the server system 320B, the memory system 320C, and/or the printing system 320D. In the manner described above with regard to the server system 320A, the network management system 200A can receive and analyze status signals 4101B, 410C, and/or 410D from the server system 320B, the memory system 320C, and/or the printing system 320D, respectively. If a malfunction with regard to one or more of the network devices 320B, 320C, and/or 320D is detected, the network management system 200A can identify one or more corrective actions for remedying each malfunction in the manner discussed above. The network management system 200A likewise can generate a control signals 420B, 420C, and/or 420D, as necessary, which control signals include information related to the appropriate corrective action, and can provide the control signals 420B, 420C, and/or 420D to the respective the network devices 320B, 320C, and/or 320D. The network devices 320B, 320C, and/or 320D can receive the control signals 420B, 420C, and/or 420D, respectively, and are configured to implement the identified corrective actions in the manner described above.

The invention is susceptible to various modifications and alternative forms, and specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives falling within the spirit and scope of the claims.

1. A network management system for detecting and remedying malfunctions in a network device configured to transmit status signals at approximately a preselected time interval under normal operating conditions, comprising:
a communication interface for communicating with the network device; and
a processing system being configured to receive the status signals via said communication interface and to generate a control signal identifying appropriate corrective action if the status signals are not received substantially in accordance with the preselected time interval.

2. An information system, comprising:
a network system;
a network device coupled with said network system and configured to transmit status signals at approximately a preselected time interval under normal operating conditions; and
a network management system coupled with said network system and being configured to receive said status signals via said network system, to generate a control signal identifying appropriate corrective action if said status signals are not received substantially in accordance with said preselected time interval, and to provide said control signal to said network device via said network system.

3. A method for detecting and remedying malfunctions in a network device, comprising:
providing said network device configured to transmit status signals at approximately a preselected time interval under normal operating conditions;
receiving said status signals by a network management system via a network system;
generating a control signal identifying appropriate corrective action if said status signals are not received by the network management system substantially in accordance with said preselected time interval;
receiving said control signal by said network device via said network system; and
implementing said corrective action via said network device.
